(19) United States
(12) Patent Application Publication
(10) Pub. No.: US 2003/0165290 A1
(43) Pub. Date: Sep. 4, 2003

(54) Optical signal altering lensed apparatus and method of manufacture

(76) Inventors: Venkata A. Bhagavatula, Big Flats, NY (US); Nagaraja Shashidhar, Painted Post, NY (US); Bryan J. Wolfe, Hammondsport, NY (US)

Correspondence Address: CORNING INCORPORATED, SP-TI-3-1, CORNING, NY, 14831

(21) Appl. No.: 10/202,515

(22) Filed: Oct. 21, 2002

Related U.S. Application Data
(60) Provisional application No. 60/361,787, filed on Mar. 4, 2002.

(51) Int. Cl. G02B 6/32

(52) U.S. Cl. 385/33

(57) ABSTRACT

A lensed apparatus for altering the mode field of an optical signal is disclosed. The apparatus includes an optical fiber biconic lens disposed on an end of the optical fiber such that the optical fiber and the biconic lens define an optical axis. The biconic lens includes an external surface defined by two different curves disposed substantially orthogonal to one another, a major curve C₁ and a minor curve C₂, wherein C₁ and C₂ intersect at or near the optical axis. A method of manufacturing a lensed apparatus for altering the mode field of an optical signal, and an optical assembly are also disclosed.

### CROSS REFERENCE TO RELATED APPLICATIONS

This application claims the benefit of U.S. Provisional Application Serial No. 60/361,787, filed Mar. 4, 2002, and entitled, “Beam Altering Fiber Lens Device and Method of Manufacture,” which is hereby incorporated herein by reference.

### BACKGROUND OF INVENTION

1. Field of the Invention

The present invention relates generally to optical devices for mode-transforming interconnections, and more particularly, to an anamorphic mode-transforming apparatus configured to facilitate high efficiency coupling of optical signals passed between optical components and/or other waveguides having different mode fields.

While the present invention is subject to a wide range of applications, it is particularly well suited for coupling sources of elliptically-shaped optical signals, such as laser diodes and semiconductor waveguides, to optical fibers having circularly symmetric mode fields.

2. Technical Background

Coupling optical signals passed between signal sources, such as laser diodes, optical fibers, and Semiconductor Optical Amplifiers (SOAs), and other optical components, such as optical fibers, specialty fibers, SOAs and the like, with a high coupling efficiency, is an important aspect of optical communications. A conventional light-emitting module incorporated in an optical communications system generally includes a semiconductor laser, such as a laser diode, serving as a light source, an optical fiber having a light carrying core, and a lens such as a spherical lens, self-focusing lens or aspherical lens interposed between the semiconductor laser and optical fiber for converging the laser beam onto the optical fiber core. Since the light-emitting module typically requires high coupling efficiency between the semiconductor laser and the optical fiber, the module is preferably assembled with the optical axes of the semiconductor laser, lens, and optical fiber aligned with each other in order to achieve maximum coupling power. The relatively large size and high cost of early light-emitting modules, due in part to lens spacing and aligmnent issues, have driven advancement in the field and have resulted in a number of alternative approaches.

One such approach is the use of a graded-index (GRIN)-rod lens. Unlike other lenses, the index of refraction of a GRIN-rod lens is radially-dependent and is at a maximum at the optical axis of the rod lens. Generally speaking, the refractive index profile across a GRIN-rod lens is parabolic in shape, and thus it is the lens medium itself, rather than the air-lens interface, that performs the lensing. Accordingly, unlike conventional lenses, GRIN-rod lenses have planar input and output surfaces making refraction at these surfaces unnecessary. This characteristic enables optical elements at either end of the lens to be fixed in place with index-matching glue or epoxy. The index gradient is typically produced by an ion-exchange process that is both time-consuming and expensive. A typical GRIN-rod lens, for example, may be produced by ion-exchange of thallium or cesium-doped silica glass. A molten salt bath may be used for the ion-exchange process such that sodium and either thallium or cesium ions diffuse out of the glass, while potassium ions diffuse into the glass from a 500° C. KNO₃ bath.

Another approach has been to form a microlens on an end of an optical fiber to provide optical coupling between a semiconductor laser and an optical waveguide. In such an approach, the lens is directly and integrally formed on an end face of the optical fiber at a portion of the fiber on which light from the light source is incident. Such an optical fiber is hereafter referred to as a, “lensed optical fiber”. When manufacturing light-emitting modules using such lensed optical fibers, the number of required component parts can be reduced since there is no need for light-converging lenses apart from the fiber itself, and since the number of operations associated with axial alignment may also be reduced. Lensed optical fibers are referred to as anamorphic lensed optical fiber when the lens formed on the end of the optical fiber is capable of changing the mode field of an optical signal passed therethrough. More specifically, an anamorphic lens formed on the end of the optical fiber is generally capable of changing the elliptical mode field of an optical signal emitted from a laser diode to a substantially circularly symmetric optical signal, which can be more efficiently coupled to the core of an optical fiber having a circularly symmetric mode field.

Each of the above-described approaches have various utilities and advantages that are well known in the art. Each approach does, however, have its own set of limitations. For example, while conventional GRIN-rod lens technology provides excellent symmetrical focusing characteristics for optical signals passed therethrough, GRIN-rod lenses alone generally do not significantly alter the geometric shape of an optical signal as is often required for efficient optical signal coupling applications. In addition, since it is the material characteristics of the GRIN-rod lens itself that provides the focusing, precise manufacturing techniques are necessary in order to provide controlled variation of the refractive index profile of the GRIN-rod lens needed for a particular application.

Likewise, while anamorphic fiber lenses readily facilitate the changing of the geometric shape of the optical signal or beam passing through them, the range of available working distances for anamorphic lens applications is somewhat limited. Accordingly, if suitable working distances are not available for particular applications, coupling losses may be significant, thereby making many coupling applications impractical.

One such lensed optical fiber is shown in FIGS. 1 and 2. The particular lensed optical fiber depicted in FIGS. 1 and 2 is an anamorphic lensed optical fiber in that the lens formed on the end of the optical fiber is capable of changing the mode field of an optical signal passed therethrough. More specifically, the anamorphic lens formed on the end of the optical fiber is capable of changing the elliptical mode field of an optical signal emitted from a laser diode to a substantially circularly symmetric optical signal, which can be more efficiently coupled to the core of the optical fiber.

As shown in FIG. 1, lensed optical fiber 10 having a core 11 and a cladding 12 includes a wedged-shaped fiber microlens 13 on one end thereof. The microlens includes a pair of planar surfaces 14 and 16 that intersect at a line 18 (FIG. 2) that substantially bisects core 11. The microlens further includes surfaces 20 and 22 that intersect surfaces 14 and 16, respectively, at lines 24 and 26 (FIG. 2), respectively. The slopes of surfaces 14 and 16 are designated as θ while the slopes of surfaces 20 and 22 are designated as Φ, wherein Φ is greater than θ. The angles θ and Φ are measured with respect to a plane 28 perpendicular to fiber axis 19. Lines of intersection 24 and 26 of the first and second pairs of surfaces preferably intersect the core as shown in FIG. 2. Moreover, the area of surface 14 is preferably substantially equal to the area of surface 16. In other words, the central portion of lens 13 is preferably symmetrical about a plane containing line 24 and line 18.

Wedged shaped fiber microlens 13 depicted in FIGS. 1 and 2 is generally produced by causing fiber 10 to engage a grinding wheel (not shown) at an angle sufficient to form planar surface 14 at an angle θ with respect to plane 28. Fiber 10 is then rotated 180° and brought into engagement with the grinding wheel (not shown) at an angle sufficient to form planar surface 16 at an angle θ with respect to plane 28. This process is then repeated to form planar surfaces 20 and 22, each at an angle Φ with respect to plane 28. As shown in FIG. 3, a cross section of fiber 10 taken along lines 3-3 of FIG. 1 has a race track shape having substantially planar top and bottom surfaces 30 and curved side surfaces 32.

While the resulting double wedge lens does function as an anamorphic lens in one direction, it is not without shortcomings. More specifically, because the lensed face of optical fiber 10 is not spherical or aspherical as shown in FIG. 3, the optical signal or light passing through the lens is subject to significant aberration, and the distortions in the optical wavefront are significant. Although the elliptical mode field of a laser diode may be fairly efficiently matched with the mode field of the optical fiber via the lens 13 depicted in FIGS. 1-2, the optical signal phase fronts are not substantially flat when they fall on the fiber. As mentioned previously, this is, at least in part, a function of the flat surfaces 30 depicted in FIG. 3.

What is needed therefore, but presently unavailable in the art, is a lensed apparatus for optical signal coupling applications that overcomes these and other shortcomings associated with the use of anamorphic lenses or GRIN-rod lenses alone. Such a lensed apparatus should be capable of changing the geometric shape and other mode field characteristics of an optical signal passing through the apparatus, while at the same time providing design flexibility that will limit coupling losses, allow a broader range of acceptable working distances, minimize phasefront aberrations, and generally provide greater control and efficiency in optical signal coupling applications. Such a lensed apparatus should be relatively inexpensive to manufacture, be relatively easy to mass produce, and in general, have a far broader range of applications without significantly altering the material properties and characteristics of the lenses themselves. It is to the provision of such a lensed apparatus that the present invention is primarily directed.

### SUMMARY OF THE INVENTION

One aspect of the present invention relates to a lensed apparatus for altering the mode field of an optical signal. The apparatus includes an optical fiber and a biconic lens disposed on the end the optical fiber such that the optical fiber and the biconic lens define an optical axis. The biconic lens includes an external surface defined by two different curves disposed substantially orthogonal to one another, a major curve C₁ and a minor curve C₂, wherein C₁ and C₂ intersect at or near the optical axis.

In another aspect of the present invention is directed to a method of manufacturing a lensed apparatus. The method includes the step of disposing a biconic lens on one end of an optical fiber such that the optical fiber and biconic lens define an optical axis, the biconic lens including an external surface defined by two different curves disposed substantially orthogonal to one another, a major curve C₁ and a minor curve C₂, where C₁ and C₂ intersect at or near the optical axis.

In yet another aspect the present invention is directed to an optical assembly. The assembly includes an optical component, a substrate configured to support the component, and a lensed apparatus positioned on the substrate and in relation to the optical component to change the mode field of an optical signal passed between the lensed apparatus and the optical component. The lensed apparatus includes an optical fiber and a biconic lens disposed on an end of the optical fiber such that the optical fiber and the biconic lens define an optical axis. The biconic lens includes an external surface defined by two different curves disposed substantial orthogonal to one another, a major curve C₁ and a minor curve C₂, where C₁ and C₂ intersect at or near the optical axis.

The lensed apparatus of the present invention results in a number of advantages over other mode-transforming devices known in the art. In one respect, because a biconic lens may be formed directly on an end of a spacer rod having a substantially uniform refractive index as measured from the longitudinal axis of the rod extending radially to the exterior surface of the rod, the lensed apparatus of the present invention may be designed to provide for greater working distances between the light emitting surface of the optical signal source and the lens itself. Moreover, since the lensed apparatus of the present invention has no planar surfaces where a significant amount of the power enters the apparatus from the optical signal source, there are fewer distortions in the optical signal wavefront, and any distortions are therefore far less significant than other mode-transforming apparatus known in the art. Accordingly, the phase front aberrations are generally smaller and less significant resulting in flatter phase fronts falling on the core of the optical fiber. As a result, coupling efficiency is greatly improved.

In addition to these advantages, the utilization of a spacer rod may itself provide a number of advantages in the use and manufacture of the present invention. The spacer rod may be fabricated such that it has the predetermined characteristics for more than one mode-transforming application. Since the lens may be formed on the spacer rod rather than the fiber itself, spacer rods having the same length, formed of the same materials, having the same aspect ratios, and having the same cross-sectional areas may be affixed to pigtail fibers having different characteristics and/or mode fields. Thereafter, each spacer rod may be altered to provide the required mode field transforming functionality required for the particular fiber pigtail to which each rod is affixed. As will be described in greater detail, this may preferably be accomplished by cutting each rod to the desired length and shaping the cut end of each rod to have the necessary radii of curvature. This aspect of the present invention provides for large scale production of rods, which in turn facilitates ease of manufacture, reduced costs associated with the manufacturing process, and greater economies of scale.

Additional advantages are provided by the method of manufacturing a lensed apparatus in accordance with the present invention. More specifically, the lensed apparatus of the present invention may preferably be fabricated such that certain features of the biconic lens, the spacer rod (when utilized), or both may be altered without impacting the design characteristics of the unaltered features of the lensed apparatus. In this way, a spacer rod fabricated for a specific application may be used for other applications as well. For example, the lensed apparatus may be fashioned such that the mode field of an optical signal passing therethrough may be changed from an elliptical mode field to a circular mode field, from a circular mode field to an elliptical mode field, or from a mode field having one ellipticity to a mode field having a different ellipticity, as desired. In addition, the lensed apparatus of the present invention may be designed such that it can alter the mode field of an optical signal passing through the lensed apparatus in either direction.

In addition to these advantages, spacer rods may be fabricated in accordance with the present invention such that they have the predetermined material characteristics for more than one mode-transforming application. Since the biconic lens is preferably formed on a coreless spacer rod or fiber affixed to the optical fiber, rather than the on the optical fiber itself, coreless spacer rods having the same length, formed of the same materials, having the same aspect ratios, and having the same cross-sectional areas may be affixed to pigtail fibers having different characteristics and/or mode fields. Thereafter, each coreless spacer rod may be altered, by cleaving to the appropriate length, for example, to provide the required mode field transforming functionality required for the particular fiber pigtail to which each spacer rod is affixed. As will be described in greater detail, this may preferably be accomplished by cleaving or otherwise cutting each spacer rod to the desired length and shaping the cut end of each rod to have the desired mode transforming effect.

Manufacturing of the spacer rod in accordance with the present invention provides additional advantages. Generally speaking, the spacer rod has a substantially uniform refractive index profile and is made from silica, some other high silica glass containing material, or may be a 96% silica glass manufactured by Coming, Incorporated, and known as Vycor®. Generally speaking, and in accordance with the present invention, the spacer rod may be cylindrical in shape, may be rectangular in shape, or may be manufactured to take on some other geometric shape. Spacer rods are preferably manufactured from an approximately one (1) meter long rod or blank that is drawn, using conventional fiber manufacturing techniques and equipment, to the desired dimension, such as, but not limited to, 125.0 microns. Generally speaking, the spacer rod is drawn in kilometer lengths and thereafter cut or cleaved to the appropriate length for the particular mode-transforming application.

In applications where a biconic lens is to be formed on an end of a spacer rod, it is advantageous to utilize a spacer rod that is preshaped for the particular mode-transforming application. For example, and in accordance with the present invention, when a particular application requires that a substantially circularly symmetric mode field be transformed to a substantially elliptical mode field, it may be preferable to form a biconic lens in accordance with the present invention on the end of a spacer rod that is substantially rectangular in shape rather than on the end of a cylindrical rod. In such instances it may be preferable to first form a blank approximately one (1) meter in length that is itself rectangular in shape. The rectangular blank may then be drawn using conventional fiber drawing techniques and equipment to form a substantially rectangular spacer rod having a desired, largest outside dimension, of approximately 125.0 microns. In this way, several kilometers of substantially rectangular shaped spacer rod material may be drawn from a single blank and thereafter cut to the desired lengths to create spacer rods having the desired optical properties. While the edges of the resultant rectangular spacer rod material may likely become somewhat rounded during the drawing process, a substantially rectangular shape will be maintained provided the temperature of the draw furnace, the drawing speed, and the tension under which the rod material is drawn are controlled. Moreover, the aspect ratios and other optical properties of the final cleaved rectangular spacer rods formed by the drawing process will preferably be substantially maintained. Such processing facilitates mass manufacturing and controlled dimensions of the final spacer rod. By forming the spacer rod in this manner, the end of the spacer rod is much more closely sized to the dimensions and surface curvatures of the biconic lens that will be formed on the end of the spacer rod. As a result the amount of grinding and polishing typically required to form the biconic lens is reduced compared to the amount of grinding and polishing typically necessary to form a wedge shaped biconic lens on the end of a cylindrical spacer rod.

All of the above-mentioned aspects of the present invention provides for large scale production of spacer rods, which in turn facilitates ease of manufacture, reduced costs associated with the manufacturing process, and greater economies of scale.

Additional features and advantages of the invention will be set forth in the detailed description which follows and in part will be readily apparent to those skilled in the art from that description or recognized by practicing the invention as described herein.

It is to be understood that both the foregoing general description and the following detailed description are merely exemplary of the invention, and are intended to provide an overview or framework for understanding the nature and character of the invention as it is claimed. The accompanying drawings are included to provide further understanding of the invention, illustrate various embodiments of the invention, and together with the description serve to explain the principles and operation of the invention.

### BRIEF DESCRIPTION OF THE DRAWINGS

FIG. 1 is a schematic illustration of a dual wedge anamorphic microlens known in the art.

FIG. 2 is an end view of the lens depicted in FIG. 1.

FIG. 3 is a cross-sectional view taken along lines 3-3 of the lens depicted in FIG. 1.

FIG. 4A schematically illustrates a top view of a preferred lensed apparatus in accordance with the present invention.

FIG. 4B schematically illustrates a side elevational view of the lensed apparatus depicted in FIG. 4A.

FIG. 4C schematically illustrates a top view of an exemplary tapered lensed apparatus in accordance with one aspect of the present invention.

FIG. 4D schematically illustrates a side elevational view of the tapered lensed apparatus depicted in FIG. 4C.

FIG. 5A is a cross-sectional view of a first alternative exemplary embodiment of the lensed apparatus of the present invention.

FIG. 5B is a cross-sectional view of a second alternative exemplary embodiment of the lensed apparatus of the present invention.

FIG. 5C is a perspective view of a third alternative exemplary embodiment of the lensed apparatus of the present invention.

FIG. 5D is a perspective view of a fourth alternative exemplary embodiment of the lensed apparatus of the present invention.

FIG. 5E schematically illustrates a partial top view of the spacer rod depicted in FIG. 5A illustrating aspects of a biconic lens.

FIG. 5F schematically illustrates a partial side view of the spacer rod depicted in FIG. 5A illustrating additional aspects of the biconic lens.

FIG. 5G is a perspective view of the spacer rod and biconic lens depicted in FIG. 5F.

FIG. 5H is a cross-sectional view of the biconic lens taken along lines 5H-5H of FIG. 5F.

FIG. 5I schematically illustrates a top view of a fifth alternative exemplary embodiment of the lensed apparatus of the present invention.

FIG. 5J schematically illustrates a side elevational view of the lensed apparatus depicted in FIG. 5I.

FIG. 6 schematically illustrates a preferred method of forming a wedge angle in accordance with the present invention.

FIG. 7A is a photomicrograph depicting a partial side view of the spacer rod depicted in FIGS. 4A.

FIG. 7B is a photomicrograph depicting a partial top view of the spacer rod depicted in FIG. 4B.

FIG. 7C is a photomicrograph taken from the end of the spacer rod depicted in FIG. 4A at the lens surface.

FIG. 7D is a photomicrograph taken from the end of the spacer rod depicted in FIG. 4A a distance of approximately 100.0 microns from the lens surface.

FIG. 8 schematically illustrates a side view of a preferred optical assembly in accordance with the present invention.

FIGS. 9-13 schematically depict a preferred method of manufacturing a lensed apparatus in accordance with the present invention.

FIG. 14 schematically depicts an alternative preferred method of manufacturing a lensed apparatus in accordance with the present invention.

FIG. 15 schematically illustrates a method of determining the design variables for a lensed apparatus in accordance with the present invention.

FIG. 16 is a graph depicting the coupling efficiency versus working distance for the sets given in the example.

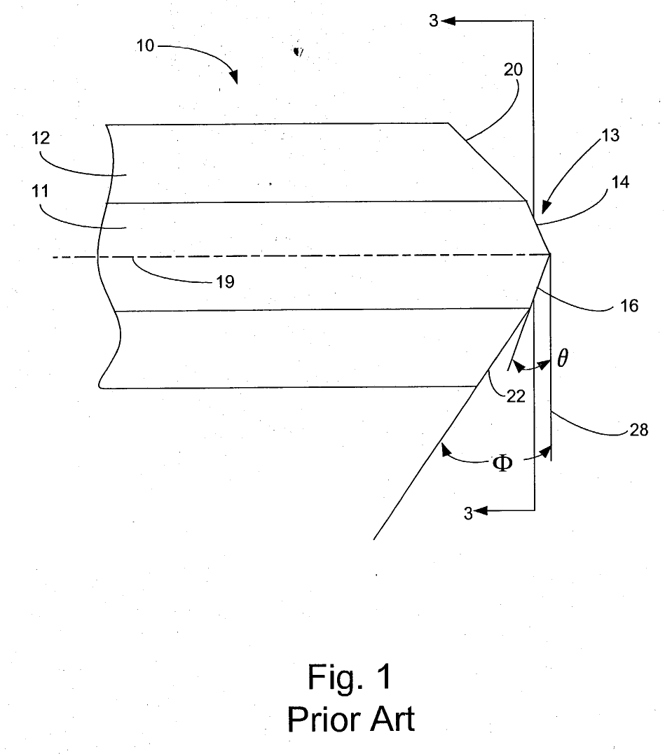

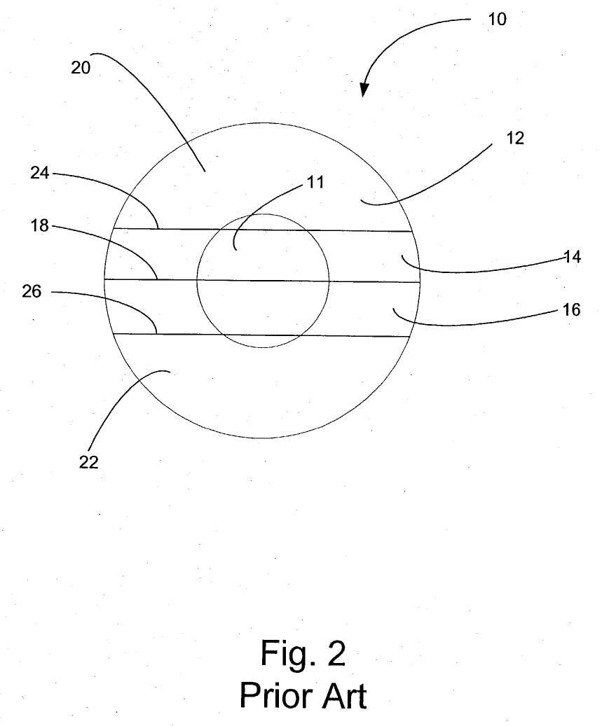

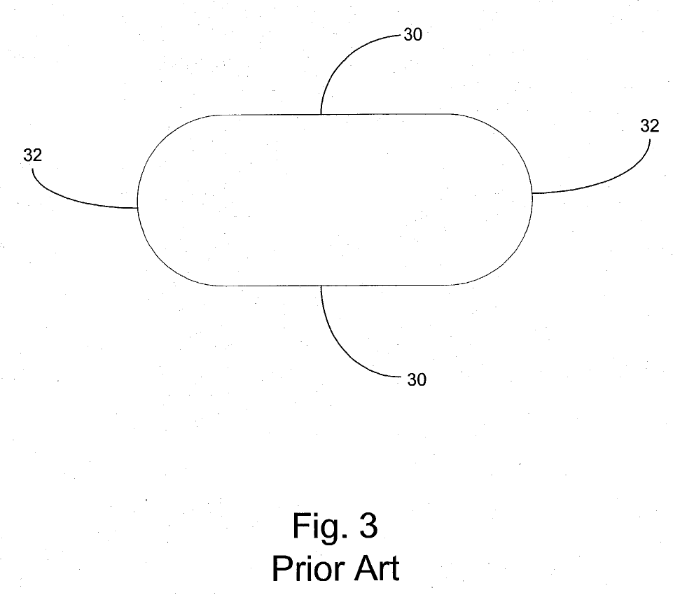

### DETAILED DESCRIPTION OF THE PREFERRED EMBODIMENTS

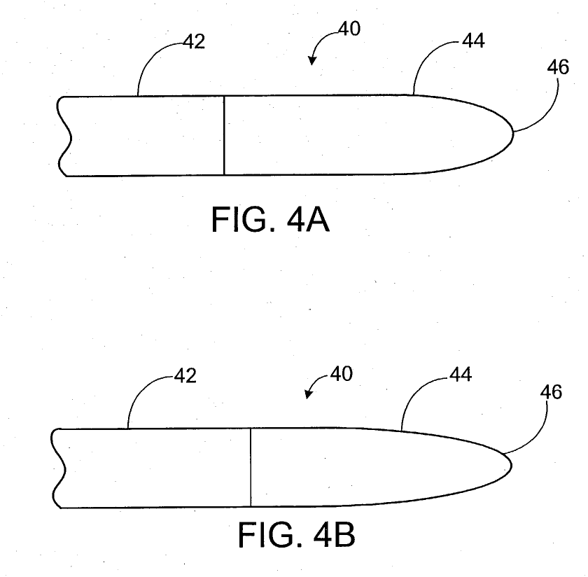

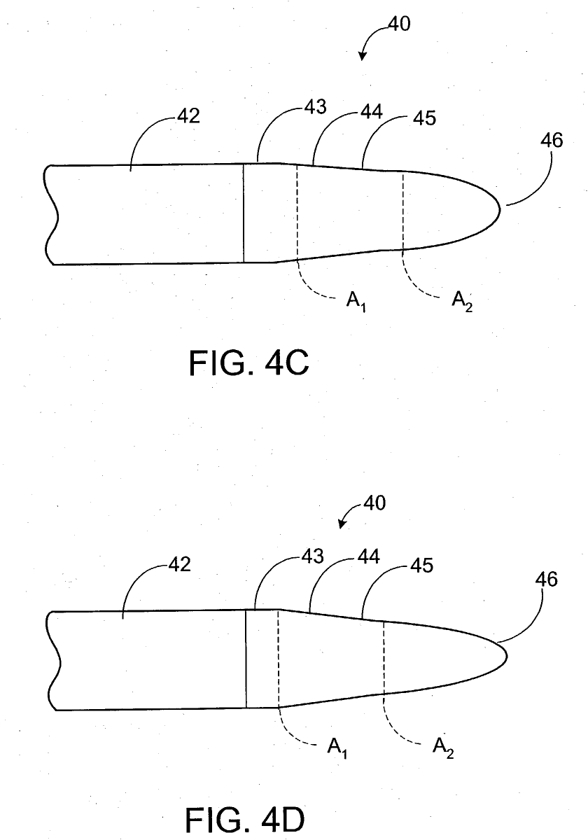

Reference will now be made in detail to the present preferred embodiments of the invention, examples of which are illustrated in the accompanying drawing figures. Wherever possible, the same reference numerals will be used throughout the drawings to refer to the same or like parts. An exemplary embodiment of the lensed apparatus of the present invention is shown in FIGS. 4A and 4B and is designated generally throughout by reference numeral 40.

Generally speaking, exemplary lensed apparatus 40 depicted in the top view of FIG. 4A and in the side view of FIG. 4B includes an optical fiber or pigtail fiber 42, a spacer rod 44 having a constant or substantially uniform refractive index profile positioned at one end of pigtail fiber 42, and a biconic lens 46 disposed on an end of spacer rod 44 remote from pigtail fiber 42. Pigtail fiber 42 may be a standard single mode fiber, such as an SMF-28 fiber manufactured by Coming Incorporated, a polarization maintaining (PM) fiber, a multi-mode fiber or other specialty fiber, such as a high index fiber, used in optical communication systems. Moreover, pigtail fiber 42 may be circularly symmetric when viewed from the end or may be any other shape. Biconic lens 46 may be preferably formed directly on spacer rod 44 after spacer rod 44 is spliced to or otherwise disposed on pigtail fiber 42, or it may be disposed or otherwise fabricated on spacer rod 44 before spacer rod 44 is disposed on pigtail fiber 42.

In accordance with another aspect of the present invention, lensed apparatus 20 may be formed such that lensed apparatus 40 includes one or more tapered elements as shown in FIGS. 4C and 4D. Such a tapered lensed apparatus 40 may include a pigtail fiber 42, a tapered spacer rod 44, having a refractive index profile, positioned at one end of pigtail fiber 42, and a biconic lens 46 disposed on an end of spacer rod 44 remote from pigtail fiber 42. For certain applications, such as laser diode coupling, the output from the laser diode may be as small as 1.0 to 2.0 microns, and the aspect ratio may be in the range from about 2.0 to about 5.0. In order to facilitate mode field matching in such applications, it is preferable that the radii of curvature of biconic lens 46 be small. However, it is also preferable that the diameter of lensed apparatus 40 be maintained at a reasonable size so that the various elements of lensed apparatus 40 may be manipulated during manufacture. Lensed apparatus 40 incorporating tapered spacer rod 44 is one preferred approach to meeting these objectives. As shown in the figures, tapered spacer rod 44 preferably includes a rod section 43 having a substantially uniform or constant radial outside dimension(s) extending longitudinally from an end of pigtail fiber 42 to phantom line A₁, and tapered rod section 45 having a changing, preferably decreasing, radial outside-dimension(s) (or sloping external surface) extending longitudinally between phantom line A₁ and A₂. Although not shown in the drawing figures, one of skill in the art will recognize that one or more of pigtail fiber 42, and/or coreless spacer rod(s) 44, may be tapered in a manner similar to tapered spacer rod 44 depicted in FIGS. 4C and 4D for any of the embodiments described and/or depicted herein.

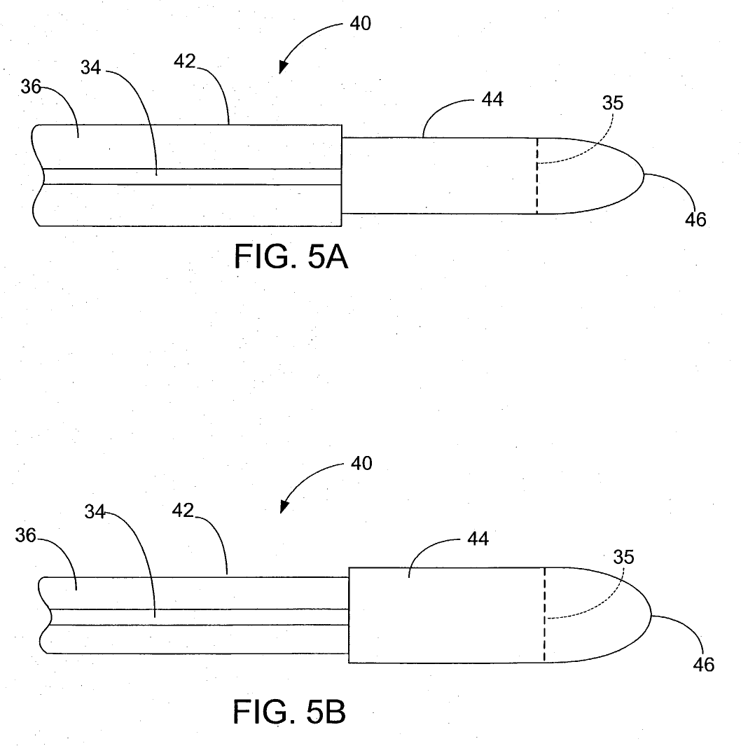

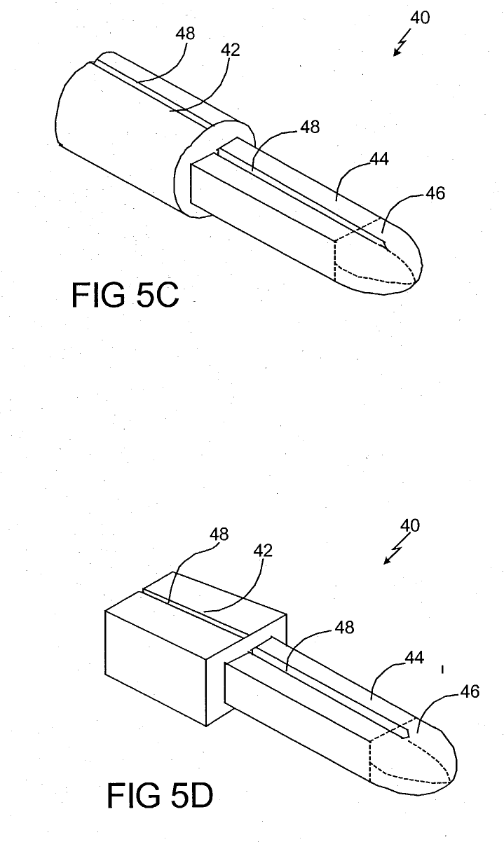

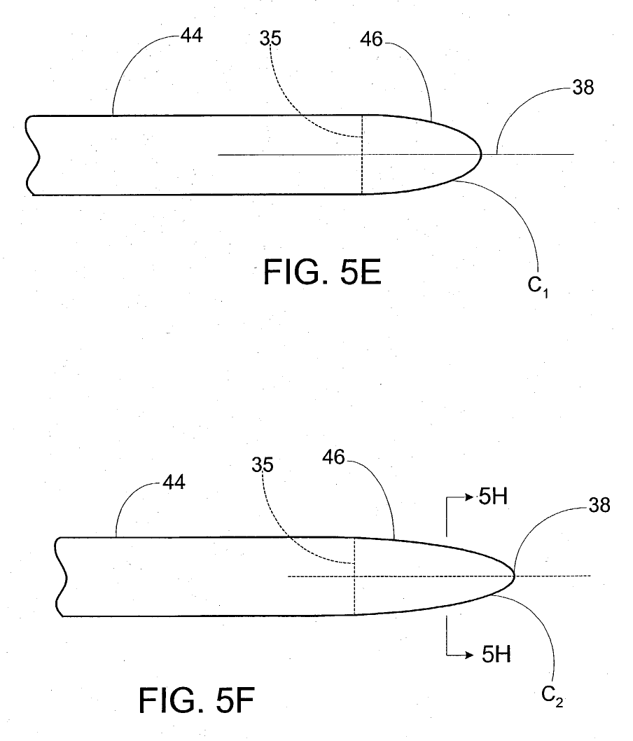

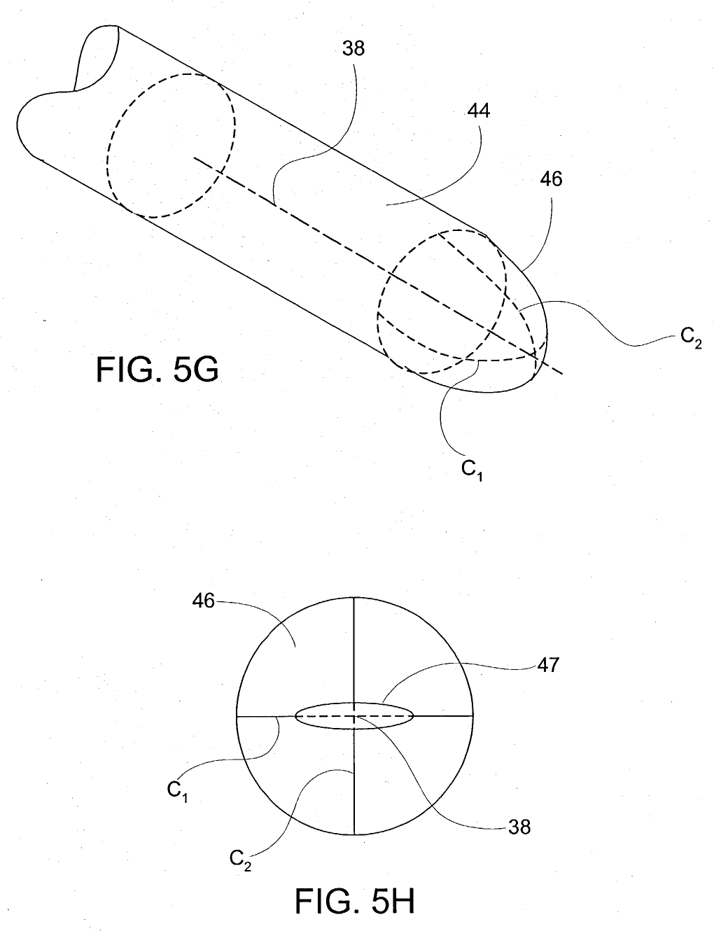

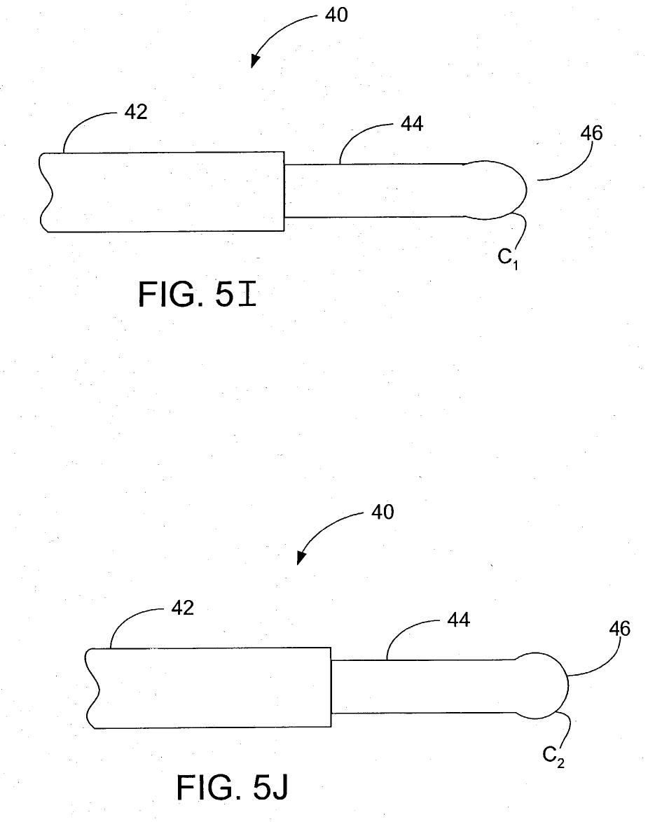

Alternative exemplary embodiments of lensed apparatus 40 of the present invention are depicted in FIGS. 5A-5D and FIGS. 5I and 5J. Unless otherwise stated herein, in each of the depicted embodiments, pigtail fiber 42 will be described as being a standard single mode optical fiber, such as an SMF-28 fiber, having an outside dimension of approximately 125.0 microns and a core dimension of approximately 8.0-10.0 microns. Those skilled in the art will recognize that other pigtail fibers having other dimension and other geometric shapes are also within the scope of the present invention. In addition, it will be understood, unless otherwise stated herein, that for any embodiment, biconic lens 46 will be disposed on lensed apparatus 40 at a location that is the most remote from pigtail fiber 42.

Referring now to FIG. 5A, multi-lens apparatus 40 includes a pigtail fiber 42 having a core region 34 bounded by a cladding region 36, and a coreless spacer rod 44 disposed on one end of pigtail fiber 42. In a preferred embodiment, the relative refractive index profile of spacer rod 44 remains substantially radially uniform between the optical axis of spacer rod 44 and the external surface of spacer rod 44. One end of spacer rod 44 is preferably spliced or otherwise affixed to one end of pigtail fiber 42 via an arc fusion splicer or some other device commonly known in the art. A biconic lens 46 is preferably disposed on the end of spacer rod 44 remote from pigtail fiber 42. In this and other exemplary embodiments disclosed herein, biconic lens 46 may preferably be formed by laser micro-machining, taper-cutting followed by polishing, conventional shaping techniques, by a combination of shaping and heating, or by other methods that will be described in greater detail below. Moreover, broken line 35 is depicted in this and other embodiments to denote the circumferential position along lensed apparatus 40 at which the curved surface of biconic lens 46 terminates in accordance with the present invention. Accordingly, and although not specifically shown in the drawing figures, biconic lens 46 may be disposed on pigtail fiber 42. In such an arrangement, broken line 35 may be co-planar and immediately adjacent the end of pigtail fiber 42 from which it depends. When so arranged, the material residing between the curved surface of biconic lens 46 and pigtail fiber 42 may be considered a “spacer rod” for the purposes of this disclosure.

Biconic lens 46 is preferably convex in shape and is preferably sized and shaped such that the mode field of an optical signal passed therethrough is changed from a mode field having the same shape, but a different size, from a substantially circularly symmetric shape to an elliptical shape, from an elliptical shape to a substantially circularly symmetric shape, and/or from one elliptical shape to a different elliptical shape. In the embodiment depicted in FIG. 5A, biconic lens 46 is fashioned directly on an end of spacer rod 44. Accordingly, biconic lens 46 does not include a cladding region. In the embodiment depicted in FIG. 5A spacer rod 44, as well as biconic lens 46, exhibits an outside diameter less than the outside diameter of pigtail fiber 42.

In the alternative exemplary embodiment depicted in FIG. 5B, lensed apparatus 40 may include all of the elements discussed above with respect to FIG. 5A. However, spacer rod 44 and at least a portion of biconic lens 46 both have a larger outside dimension than pigtail fiber 42. Generally speaking, characteristics such as, but not limited to, the mode field, structure, and size of the device being coupled to lensed apparatus 40 will be at least some of the determining factors in the size and other design features of spacer rod 44 spliced or otherwise attached to pigtail fiber 42. In addition, increasing the size of the outside dimension of spacer rod 44 and other elements of lensed apparatus 40 of the present invention may facilitate ease of manufacture and otherwise assist in the metrology during fabrication.

A spacer rod 44 that is substantially rectangular in shape may alternatively be employed as depicted in FIGS. 5C and 5D. As depicted in FIG. 5C, for example, lensed apparatus 40 includes a circularly symmetric pigtail fiber 42, and a substantially rectangular spacer rod 44, an end of which has been shaped to form biconic lens 46. The embodiment depicted in FIG. 5D, depicts each of the pigtail fiber 42, and spacer rod 44 as substantially rectangular in shape. One of skill in the art will recognize that spacer rods 44 may be cylindrical in shape, or may be some other geometric shape, such as, but not limited to square or elliptical. In addition, spacer rod 44 and pigtail fiber 42 may be marked with alignment grooves 48 as shown in the drawing figures or otherwise marked to indicate how rod 44 should preferably be aligned with pigtail fiber 42 in order to maintain the polarization axes of pigtail fiber 42. One of skill in the art will recognize that such marking is particularly useful when the geometry of the various elements of the lensed apparatus 40 is round or cylindrical, or otherwise non-planar.

A top view and a side view of a portion of spacer rod 44 depicted in FIG. 5A is schematically shown in FIG. 5E and FIG. 5F, respectively. Although biconic lens 46 depicted in FIG. 5A is being used for this discussion, the principles expressed hereafter with respect to FIG. 5E and FIG. 5F are equally applicable to the other exemplary embodiments of the lensed apparatus 40 of the present invention, regardless of whether biconic lens 46 is disposed on the end of pigtail fiber 42, on the end of a cylindrical spacer rod 44, or on the end of a spacer rod 44 that is non-cylindrical in shape.

FIG. 5E depicts a top view of a portion of spacer rod 44, while the view of spacer rod 44 in FIG. 5F is taken from the side. Regardless of the manufacturing techniques used to arrive at biconic lens 46, biconic lens 46 preferably includes an external surface preferably defined by at least two different curves. A first or major curve C₁ is preferably formed in the plane depicted in FIG. 5E, while a second or minor curve C₂ is preferably formed in the plane depicted in FIG. 5F. Preferably, curves C₁ and C₂ are substantially orthogonal to one another and intersect at or near the optical axis 38 as depicted in FIG. 5G and FIG. 5H. The shape of surface 47 of biconic lens 46 may be readily identified with reference to the cross-sectional view depicted in FIG. 5H. In the embodiment shown in FIG. 5H, the curved surface defined by the curves C₁ and C₂ defines an ellipsoid. Among other optical properties of biconic lens 46, the difference in the curvatures of curves C₁ and C₂, and their substantially orthogonal arrangement with respect to one another, provide the optical signal or beam altering functionality of Tensed apparatus 40 of the present invention. The different curves C₁ and C₂ preferably define a conic surface, and may each define a sphere, may each define an asphere, or one may define a sphere while one may define an asphere. In addition, the curves preferably define an ellipsoid, paraboloid or a hyperboloid. The result is essentially a surface that provides an anamorphic lens effect. By controlling the shape and curvature of curves C₁ and C₂ of biconic lens 46, the shape of the mode field of the optical signal passed through biconic lens 46 may be controlled.

A fifth alternative exemplary embodiment of Tensed apparatus 40 in accordance with the present invention is depicted schematically in FIGS. 5I and 5J. In the embodiment shown, Tensed apparatus 40 includes a cylindrical pigtail fiber 42, a cylindrical spacer rod 44 having a smaller outside dimension than pigtail fiber 42, and a biconic lens 46 disposed on the end of spacer rod 44 remote from pigtail fiber 42. Unlike the embodiments described above, biconic lens 46 has an outside dimension greater than the outside dimension of spacer rod 44. Like the other embodiments disclosed herein, however, biconic lens 46 is preferably defined by at least two different curves. A first or major curve C₁ is preferably formed in the plane depicted in FIG. 5I while a second or minor curve C₂ is preferably formed in the plane depicted in FIG. 5J.

Each of the above-mentioned exemplary embodiments of multi-lens apparatus 40 may share certain common manufacturing techniques. First, an appropriate spacer rod material having an operative substantially uniform index of refraction, an outside dimension, and desired geometric shape is drawn using conventional optical fiber manufacturing equipment and fiber drawing techniques. The spacer rod material is then preferably cut to an appropriate length to form a spacer rod 44, which is affixed, preferably by splicing, to a selected pigtail fiber, or to one or more additional spacer rod(s) 44 which is/are spliced to the end of pigtail fiber 42. Such spacer rods 44 are preferably coreless silica glass containing rods, which may be manufactured to have any suitable outside dimension and geometric shape, and which have a uniform or constant radial index of refraction, and thus little or no Tensing characteristics. When employed, additional spacer rods 44 provide additional design flexibility.

The spacer rod 44 may then be cleaved or taper cut to the appropriate length for a given application. The cleaved or taper cut end of the spacer rod 44 so formed may then be shaped, such as by polishing, into an intermediate wedge shape having suitable wedge angles. The parameters of the spacer rod 44, the intermediate wedge angles, and rounding radius values may be designed based upon the required working distance and pigtail fiber 42 mode field, and the final mode field shape requirements of the given coupling application. The rounding of the appropriate intermediate wedge angles results in a biconic lens 46 disposed on an end of the spacer rod 44 remote from pigtail fiber 42, wherein the external surface of the biconic lens 46 is defined by two different curves disposed substantially orthogonal to one another, a major curve C₁ and a minor curve C₂, where C₁ and C₂ intersect at or near the optical axis 38 of lensed apparatus 40 of the present invention.

The intermediate wedge angle of a uniform-index biconic lens in accordance with the present invention may be determined using a variety of criteria. Generally speaking, a preferred lens shape for coupling optical sources with small mode field diameters is a hyperbola. Accordingly, conic sections may be used to represent curves C₁ and C₂ defining the biconic surfaces. In accordance with a preferred embodiment of the present invention, and as described in greater detail with reference to H. N. Presby and C. A. Edwards, Near 100% Efficient Fibre Microlens, Electronic Letters, Vol. 28, page 582, 1992, the disclosure of which is hereby incorporated by reference herein, the asymptotes of a hyberbola defining the wedge shape and thus the curves C₁ and C₂ can be used to determine the intermediate wedge angle for the biconic lens. The resulting intermediate wedge may be rounded by heating or other methods known in the art to give the preferred hyperbolic curved shape to the spacer rod.

As shown in the schematic illustration depicted in FIG. 6, a hyperbola 50 representing the curve C₁ or C₂ is preferably defined by asymptotes 52 representing the wedge and intersecting at a central apex 54 at (h, k). The equation defining the hyperbola may be expressed as follows:

$$\frac{{( x - h )}^{2}}{{a}^{2}} - \frac{{( y - k )}^{2}}{{b}^{2}} = 1$$

Where b²=c²−a²

with c being the distance 56 between the apex 54 and the focal point 58 of the hyperbola (h+c,k) and with a being the distance 60 between the apex 54 and the hyperbola apex 62.

The asymptotes are defined by the lines:

Y=k+(b*(x−h)/a) and y=k−(b*(x−h)/a)

From the equations of the asymptotes, the wedge angle 57 may be determined as

Wedge angle=2*(tan⁻(b/a))

The independently variable curves of the external surface defined on biconic lens 46 provide the anamorphic lens effect and design flexibility to meet the mode coupling requirements for numerous applications. Moreover, the rounded wedge with a controlled radius acts as an anamorphic lens, whereas spacer rod 44 has essentially no lensing properties. By defining the parameters of the wedge, and the spacer rod 44, the properties of the anamorphic lens (biconic lens 46) such as the mode field diameter of the focused beam, its aspect ratio (i.e., its elipticity), and the image distance of the focused beam from the tip of the rounded wedge may be controlled. Such lenses provide anamorphic lens effects for optical coupling along the direction of the optical axis 38 extending through pigtail fiber 42. It is also possible to arrive at a variety of designs where the outside dimension, size, shape and index difference of the spacer rods and pigtail fibers can be varied for different applications. For example, it is possible to have the outside dimension of the spacer rods the same, smaller, or larger than the pigtail fiber to accommodate beams of varying size. The shape of the pigtail fiber and any spacer rods can be non-cylindrical, such as square or rectangular, or may be marked with alignment grooves 48 or otherwise for ease of manufacturing and to facilitate alignment with the polarization axes of the pigtail fiber 42. By aligning the planar sides or markings with the polarization axes of pigtail fiber 42, further processing, such as polishing the wedges and coupling to a laser diode or other optical component with proper polarization axes is simplified.

Returning now to the exemplary embodiments depicted in FIGS. 5C and 5D, a non-cylindrical rod such as a rectangular spacer rod 44 is preferably spliced to pigtail fiber 46. An advantage of this configuration is realized during manufacturing. Because rectangular spacer rod 44, preferably a coreless silica containing glass material having a uniform radial index of refraction, may be fabricated to closely approximate the desired shape of biconic lens 46 to be formed at the end of lensed apparatus 40, manufacturing may be simplified. For example, the formation of an intermediate wedge shape on the end of lensed apparatus 40, such as by polishing, may not be necessary. At a minimum, the amount and degree of polishing may be significantly reduced. Instead, biconic lens 46 may be preferably formed by merely reheating the end of spacer rod 44 to a temperature sufficient to reflow the glass in order to round the edges of the end of rectangular spacer rod 44. The heat applied to the end of rectangular spacer rod 44 is preferably high enough to soften the glass such that the edges are rounded without further mechanical reshaping. Accordingly, a properly shaped biconic lens 46 may be readily fashioned on an end of spacer rod 44 remote from pigtail fiber 42.

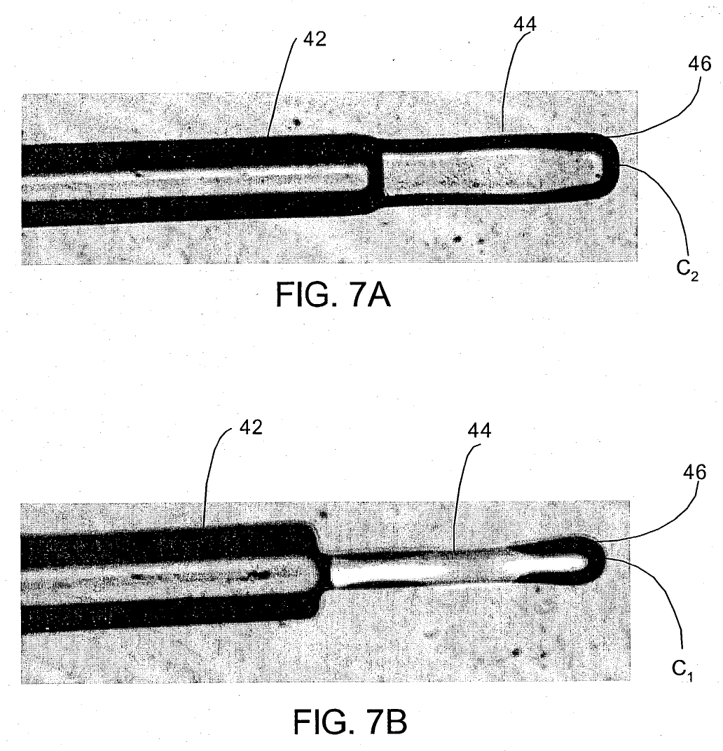

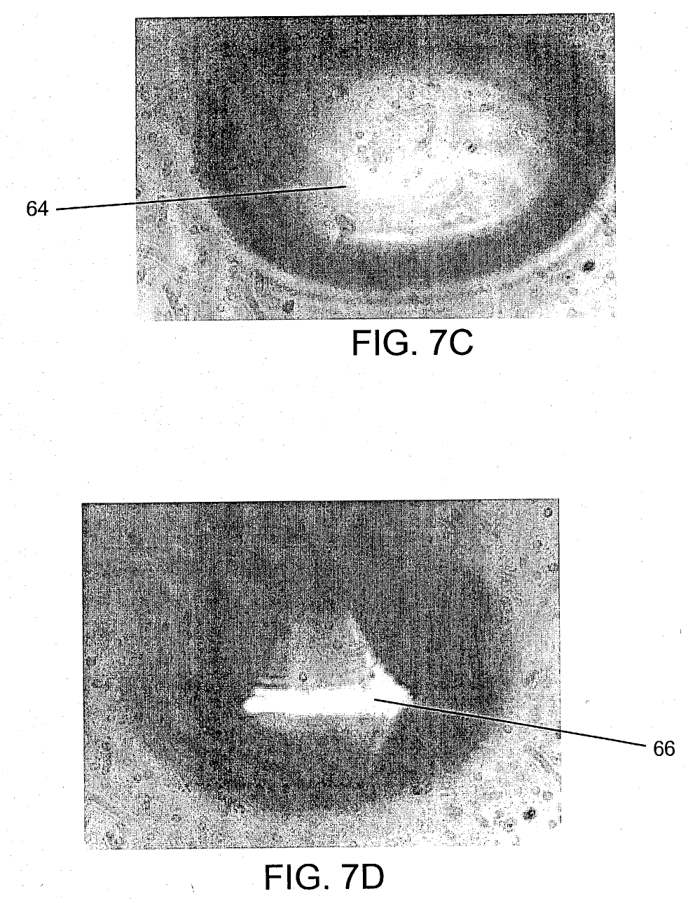

In accordance with one aspect of the operation of the present invention, and as shown in FIGS. 7A and 7B, an optical signal, preferably emitted by a laser diode or other optical device, is preferably passed through biconic lens 46, into and through spacer rod 44, and into and through pigtail fiber 42. FIG. 7A is a photomicrograph depicting a side view of a lensed apparatus 40, while FIG. 7B is a photomicrograph depicting a top view of a lensed apparatus 40. The different curves C₁ and C₂ defining the external surface of biconic lens 46 can be clearly seen in the figures. In accordance with this aspect of the present invention, a substantially elliptical mode field emitted from a laser diode or other waveguide is preferably changed to a circular mode field that substantially matches the mode field of pitgail fiber 42

In accordance with another aspect of the present invention, the shape of biconic lens 46 may change the mode field shape of the optical signal passed therethrough from a substantially circularly symmetric mode field to a substantially elliptical mode field as shown in the photomicrographs of FIGS. 7C and 7D. In accordance with this aspect of the present invention, an optical signal having a substantially circular mode field may pass through pigtail fiber 42, spacer rod 44, and through biconic lens 46. The image 64 depicted in FIG. 7C was taken under magnification from the end of lensed apparatus 40 substantially at the surface of biconic lens 46. At this location, image 64 is out of focus and is beginning to change from a circular mode field to an elliptical mode field. As shown in FIG. 7D, however, image 66, which was taken under magnification from the end of lensed apparatus 40 at a distance of approximately one-hundred (100.0) microns from biconic lens 46, is substantially elliptical. Thus, for the embodiment shown, it is at this distance of about one-hundred (100.0) microns (the image distance) that the elliptical mode field substantially matches the mode field of a component, such as a SOA, to which the optical signal is to be coupled. Accordingly, when packaging such an assembly, the SOA or other optical component having an elliptical mode field may preferably be positioned approximately 100.0 microns away from the end of biconic lens 46 for maximum coupling efficiency and thus minimum optical loss.

An exemplary optical assembly 70 in accordance with the present invention is depicted in FIG. 8. Optical assembly 70 depicted in FIG. 8 is configured for substantially in-line mode-transforming optical coupling applications. Optical assembly 70, preferably includes a substrate 72, and a source 74 of an optical signal 76, such as, but not limited to, a laser diode or other emitter. Source 74 of optical signal 76 is preferably supported on substrate 72 and a lensed apparatus 40 in accordance with the present invention is also preferably positioned on substrate 72 such that lensed apparatus 40 is capable of communicating with source 74. Optical source 74 is preferably aligned with biconic lens 46 via pedistals or stops 78 affixed to substrate 72. In accordance with one aspect of the present invention, an optical signal 76 having a substantially elliptical mode field is emitted from source 74 in the direction of biconic lens 46. Signal 76 passes through biconic lens 46 which anamorphically alters the mode field of optical signal 76. Optical signal 76 is prefereably changed from a substantially elliptical mode field to a circularly symmetric mode field and is focused such that optical signal 76 is efficiently coupled to pigtail fiber 42 having a substantially circularly symmetric mode field.

Although not required, substrate 72 may preferably be a silicon optical bench having a <111> facet etched or otherwise formed on substrate 72, and may preferably include a V-groove 79 for supporting the lensed apparatus 40 in proper alignment with signal source 74.

Although not shown in the drawing figures, it is also important that the wavefronts are matched, as closely as possible. Failure to do so may result in aberrations, which are the result of constructive or destructive interference with coupling efficiency. In the past, those skilled in the art adjusted the properties of the lenses, for instance the GRIN-rod lens, such as the refractive index profile of the GRIN-rod lens, by actually changing the chemical properties of the glass itself. This is very time consuming and does not facilitate the efficient manufacture of mode field coupling assemblies. In accordance with the present invention, the use of spacer rods, which act to move the optical signal image without adding any significant lens effect to the optical signal image, the size and number of spacer rods, and the independent control (in the x-plane and y-plane) of the shape of the curved external surface defining biconic lens 46, enable those skilled in the art to easily and efficiently substantially match these wavefronts in a manner that is practical, efficient and cost effective for mass manufacture of mode field coupling assemblies. In addition, and although not shown in the figures discussed above, the above mentioned principals are equally applicable to those embodiments of the optical assembly of the present invention where the optical signal is directed through the pigtail fiber, then through the spacer rod(s), through the biconic lens and then coupled to an optical waveguide device, such as, but not limited to an SOA or other detector/photodiode.

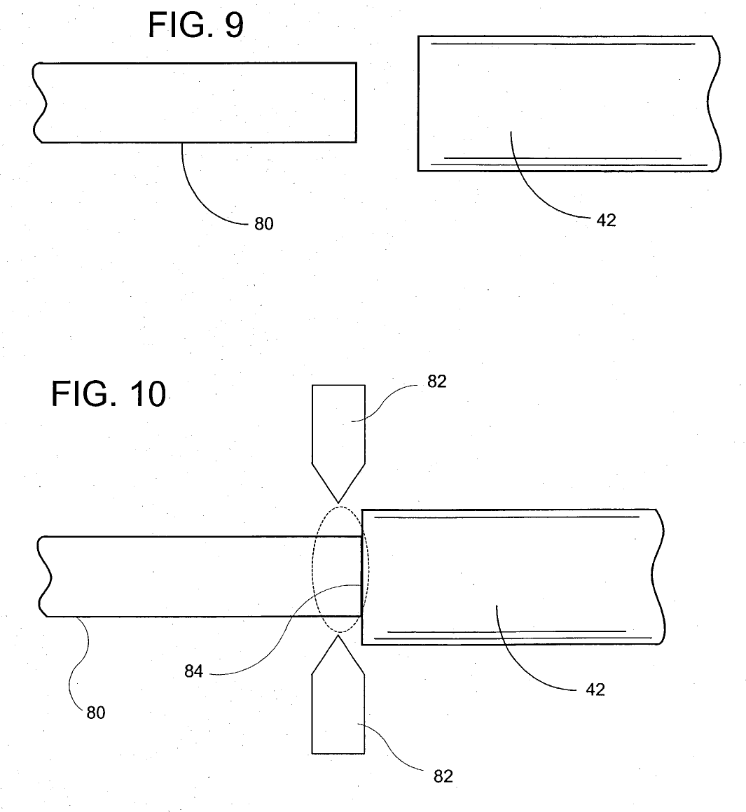

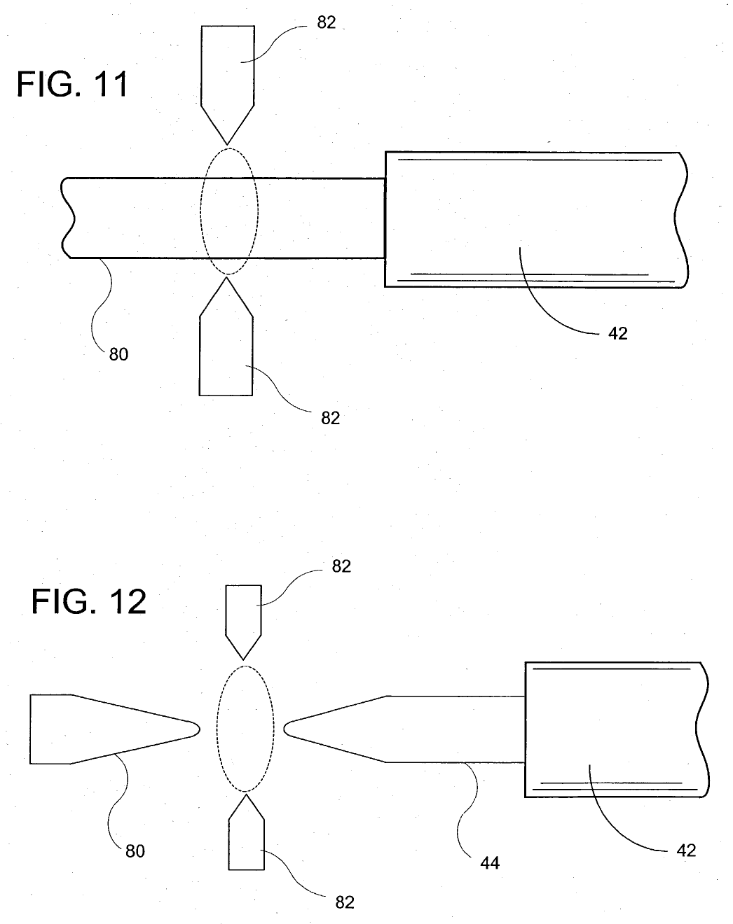

Referring to FIG. 9-13, a preferred embodiment of the process for fabricating a lensed apparatus 40 in accordance with the present invention is shown diagramatically. In FIG. 9, an optical waveguide such as a pigtail fiber 42 of the type selected for the lensed apparatus 40 is gripped and positioned using a micropositioning stage (not shown) in the desired alignment with an adequate length of spacer rod material 80. The spacer rod material 80 preferably includes light carrying characteristics such as, the appropriate aspect ratio, cross-sectional area, and other material properties, as is preferably formed from a blank using conventional fiber manufacturing draw equipment and processing techniques. The material will preferably have the desired largest outside dimension of approximately 125.0 microns. Spacer rod material 80 may be of any suitable length and cross-sectional shape, with a rectangular embodiment being shown in FIGS. 9-13. The spacer rod material 80 is similarly gripped and positioned using a micropositioning stage, with one or both of the pigtail fiber 42 and spacer rod material 80 being movable in the x, y, and z directions as well as angularly relative to one another. The pigtail fiber 42 and spacer rod material 80 are preferably moved into close confronting proximity or contact with one another, and in the vicinity of a heat source 82 such as, but not limited to a filament based splicer, CO₂ laser, arc fusion splicer, or other similar heating source, as shown in FIG. 10. Heat is applied and the pigtail fiber 42 and spacer rod material 80 contact and are pressed against one another until fused together at the splice junction 84. Pigtail fiber 42 and spacer rod material 80 are then backed off (or heat source 82 is moved, or both), to a desired or predetermined location along the spacer rod material 80 as shown in FIG. 11. The spacer rod material 80 is heated and the portions on opposing sides of heat source 82 are tensioned to draw and separate the spacer rod material 80 into two segments each having tapered ends as shown in FIG. 12, one segment of which forms the spacer rod 44 attached to pigtail fiber 42, and the remaining segment being held by the micropositioning stage may typically be connected to the supply of spacer rod material 80. The tapered end of the remaining spacer rod material 80 may be scored and separated to produce a clean end face to be used to fabricate other spacer rods 44 on other pigtail fibers 42.

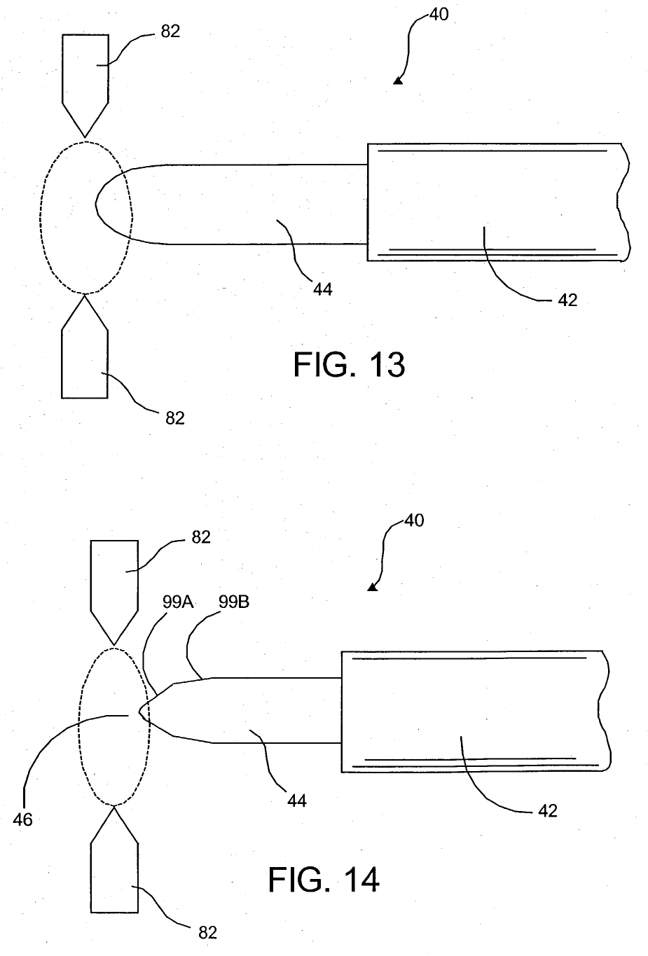

The tapered end of spacer rod 44 is then positioned proximate the heat source 82 as shown in FIG. 13, and heat is applied to the tapered end of spacer rod 44 sufficient to raise the tapered end of the spacer rod 44 to or above its softening point, whereby the tapered end of spacer rod 44 softens and deforms sufficiently so that the surface tension of the viscous glass material forms a generally rounded biconic lens 46 having an external surface defined by two different curves disposed substantially orthogonal to one another, a major curve C₁ and a minor curve C₂, wherein C₁ and C₂ intersect at or near the optical axis. As a result, biconic lens 46 is integrally attached to and spaced from the pigtail fiber 42 to form the lensed apparatus 40 of the present invention.

The process of making a “taper-cut,” or “taper-cutting,” as described above and in accordance with the present invention is described in further detail in U.S. patent application Ser. No. 09/812,108, filed Mar. 19, 2001, entitled, “Optical Waveguide Lens and Method of Fabrication,” which is hereby incorporated by reference herein. Those skilled in the art will recognize that the step of “taper-cutting” spacer rod material 80 to the correct length as described above is performed under conditions such that the rectangular rod maintains a substantially rectangular shape. This is preferably achieved by using low enough heat/temperature such that the rod material may be pulled apart to form a tapered surface, but not high enough for the surface tension to circularize the rectangular rod material 80. Moreover, the same is true for the amount of heat applied for the shaping step. A sufficient amount of heat is preferably applied to round any edges resulting from the “taper-cutting” step in order to form the biconic lens, but the heat/temperature is maintained low enough such that the rectangular rod 44 is not circularized. Since the two cross-sectional dimensions of the rectangular rod are different, the radii of curvature in the two orthogonal directions will be different leading to the biconic lens 46 of the present invention.

In mode coupling applications where a small radius of curvature is required, such as a radius of curvature of about 22.0 microns, the fraction of light collected by small mode field diameter sources is reduced and hence the coupling efficiency is typically reduced. This is due, at least in part, to the fact that small mode field diameter sources have large divergence angles. In order to obtain adequate coupling efficiency with small radii of curvatures and high divergence angles, it is often necessary to obtain short tapers and to have as much of the clear lens aperture usable as possible. In order to achieve this objective, it may be necessary to optimize the biconic lens 46 formation using a “multi-taper-cut” approach as described below with reference to FIG. 14.

In certain coupling applications, such as laser diode coupling, the output from the laser diode may be as small as 1.0 to 2.0 microns, and the aspect ratio in the range from about 2.0 to about 5.0. In order to obtain such small mode field diameters and at the same time maintain a reasonable biconic lens 46 dimension, the radius of curvature will preferably be small. As mentioned briefly above, a lensed apparatus 40 having such characteristics may be achieved with a “multi-taper-cut” approach such as that depicted in FIG. 14. In accordance with this preferred multi-taper embodiment of the method of the present invention, the initial method steps depicted in FIGS. 9-11 are carried out in substantially the same manner as described above with reference to the “taper-cut” embodiment. The once difference, however, is that the heat source is moved in a coordinated fashion in a direction away from the micropositioning stages during the tensioning step; i.e., rather than being held in a stationary position as described above. By varying the velocity and the temperature of the heat source during this tensioning step the result is the multi-taperd configuration depicted in FIG. 14. It should be noted that, unlike the steps depicted in FIGS. 12 and 13, a two-step taper cutting process is employed utilizing a heat source 82 such as, but not limited to, a filament based splicer, such as a Tungsten filament based splicer, or a CO₂ laser and mask to result in a dual-taper-cut spacer rod 44 that is remote from pigtail fiber 42. As shown in FIG. 14, the first surface 99A resulting from the first taper-cut has a more shallow slope than the second taper-cut surface 99B, proximate the end of spacer rod 44 remote from pigtail fiber 42. The multi-taper cut end of spacer rod 44 may then be heated again such as by heat source 82 in order to round any edges resulting from the multi-taper cut process. Unlike the single taper-cut process described above, the multi-taper cut process results in a surface on the end of spacer rod 44 that more closely approximates the final biconic shape of the desired biconic lens 46. The preferred shape of biconic lens is a hyperbolic shape as it reduces phase front aberations and provides better coupling with large divergent angle sources.

In other embodiments of the method of the present invention, spacer rod 44, and thus biconic lens 46, may be formed by cleaving rather than “taper-cutting” spacer rod material 80. Following the cleaving step, the cleaved end of the resulting spacer rod 46 may again be heated in a controlled fashion to round the edge of spacer rod 44 resulting from the cleaving step. Again, due to the rectangular shape of spacer rod 44, the rounding achieved by controlled heating results in a biconic lens 46 disposed on the end of spacer rod 44 remote from pigtail fiber 42. Alternatively, spacer rod material 80 may be cleaved and then shaped without heat, as by grinding with a grinding wheel followed by an optional polishing step utilizing, for instance, a polishing wheel. Generally speaking, the cleaved end of spacer rod 44 will be supported and brought into contact with the grinding wheel at an angle and rotated in order to shape the cleaved end of spacer rod 44. In a preferred embodiment of the method of the present invention, the grit size of the grinding wheel material will be in the range from about 0.3 microns to about 1.0 microns. More preferably, however, shaping may be accomplished by laser micro-machining the end of spacer rod 44.

### EXAMPLE

An example of a lensed apparatus and optical assembly in accordance with the above-mentioned embodiments of the present invention will now be described.

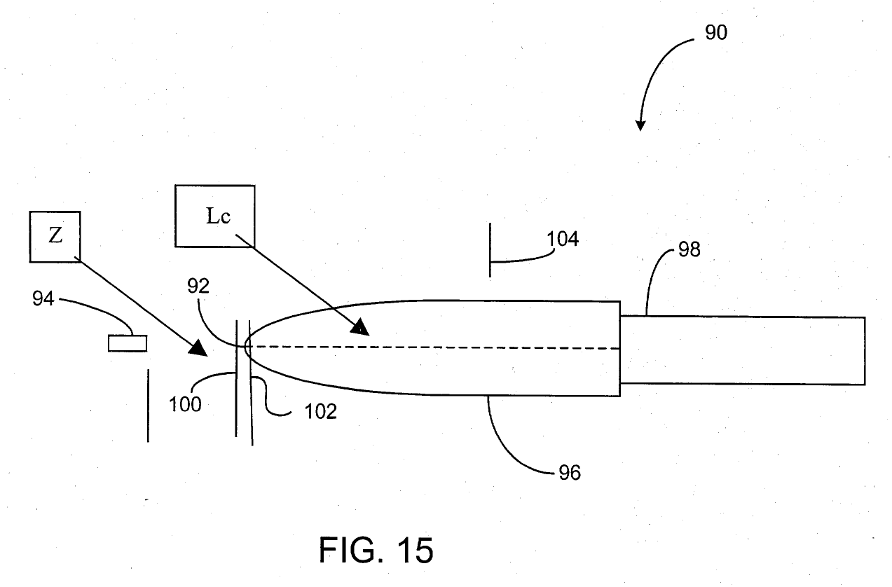

An exemplary lensed apparatus 90, including a biconic lens 92, is shown schematically in FIG. 15 with reference to the variables described below. The exemplary multi-lens apparatus includes a source 94 of an optical signal, in this case a laser diode capable of emitting a signal at an operating wavelength ‘wav’; Mode-field-diameter (MFD) in the x-direction (vertical direction) of wx0(μm), and MFD in the y-direction of wy0 (μm). The beam from the source 94 propagates through a medium (most commonly air) of index (n1) for a distance (z) before falling on a biconic lens 92 with radii of curvature of (RLx) (μm) in the x-direction and (R1y) (μm) in the y-direction that is formed on a spacer rod 96 having a radially constant refractive index profile and a length (Lc) and index (nc) . The MFD of the optical signal before the cylindrical biconic lens is wx1, and wy1, and beam wavefront radii of curvature are rx1, and ry1. The optical signal is transformed by the biconic lens to a beam with MFD and wavefront radii of curvatures of wx2, wy2 and rx2, ry2, respectively. For a thin lens, wx1=wx2 and wy1=wy2, but rx2 and ry2 are not generally the same as rx1 and ry1. The beam then propagates through the spacer rod 96 section of length Lc and index nc. The beam characteristics after this propagation are wx3, wy3 and rx3, and ry3. The objective of the design is to make wx3=wy3=wsmf, where (wsmf) is the circular MFD of the standard single mode pigtail fiber 98. Another objective is to make rx3 and ry3 as close to a flat wavefront as possible to maximize the coupling efficiency to the pigtail fiber. This objective may be achieved for any given source 94 and pigtail fiber 98 by modifying the design variables such as Z, Rx, Ry, Lc of the biconic lens 92, and the spacer rod 96. The objective also is to make Z reasonably large for reasonable tolerances and practical packaging requirements without compromising the coupling efficiency.

The beam transformation can be calculated for the gaussian beams using the ABCD matrix procedures for the complex beam parameter q as disclosed in the references incorporated herein by reference, or using the beam propagation techniques. The design is preferably optimized for the best coupling efficiency for any desired z, as well as the source 94 and pigtail fiber 98 characteristics. The material characteristics n1, nc, ng, and ns can be varied to some extent, but practical material considerations limit their values. For example, n1 is generally equal to 1 (air), nc is mostly silica or doped silica with values of 1.45 μm or at least near the 1.3-1.55 μm wavelength range. The same is true for ng and nsmf

Complex beam parameter q is defined as:

(1/q)=(1/r)−i*(wav/(pi*w\hat{ }2*n)

where r is the wavefront radius of curvature, w is the gaussian mode field radius, and wav is the wavelength of light.

The q parameter transformation from input plane 100 to output plane 102 is given by:

q2=(A*q1+B)/(C*q1+D)

where A, B, C, D are the elements of the ray matrix relating the ray parameters of the input and output plane, 100 and 102, respectively.

1) ABCD matrix for free space propagation of length

$$z = [ \begin{matrix}1 & z \\ 0 & 1\end{matrix} ]$$

2) for going from a medium of index n1 to

$$n ( no length ) = [ \begin{matrix}1 & 0 \\ 0 & ( n1 / n )\end{matrix} ]$$

3) for a lens of radius of curvature

$$R = [ \begin{matrix}1 & 0 \\ - ( n2 - n1 ) / n2 * R ) & n1 / n\end{matrix} ]$$

Assuming an infinitely thin biconic lens, the lens geometry and the variables of the design and MFD parameters at specific locations can be derived as follows:

| Plane 99: | Output of source 94: wav,wx0,wy0 - Wavelength and x, | |
|---|---|---|
| | and y mode fields of the source 94 | |
| Plane 100: | Propagate through Z, of material index (n1) but before the | |
| | biconic lens 92 | |
| | wx1,wy1 | Mode field diameters of the beam at plane 100 |
| | rx1,ry1 | Wavefront Radius of Curvature |

| | |
|---|---|
| Plane 102: | Just after the biconic lens 92 of radius Rx and Ry with |
| | material index |
| | nc |
| | wx2,wy2 |
| | rx2,ry2 |
| Plane 104: | Propagation in spacer rod 96 of length Lc, and index nc and |
| | just in front of the pigtail fiber 98 |
| | wx3, wy3 |
| | rx3, ry3 |

### SPECIFIC EXAMPLES FOR THE LENSED APPARATUS

Using the procedure indicated above, the design variables of the lensed apparatus for a laser diode coupling application may be calculated and optimized. The design parameters of an exemplary optical assembly incorporating a lensed apparatus of the present invention are listed below:

| | | |
|---|---|---|
| Laser diode characteristics: | Wavelength: | 1.55 μm |
| | Mode-field radius in X-direction | 1.50 μm |
| | w0x: | |
| | Mode Filed radius in | 6.0 μm |
| | Y-direction w0y: | |

OTHER DESIGN PARAMETERS

| | |
|---|---|
| Set 1 | |
| X-Y radii of curvature of biconic lens RLx;Rly | 5 μm; 13 μm |
| Length of Core-less spacer rod Lc: | 50 and 65 μm |
| Set 2 | |
| X-Y radii of curvature of biconic lens RLx;Rly | 10 μm; 20 μm |
| Length of Core-less spacer rod Lc: | 9, 100 and 110 μm |
| SMF pigtail Mode-field radius | 5.2 μm |

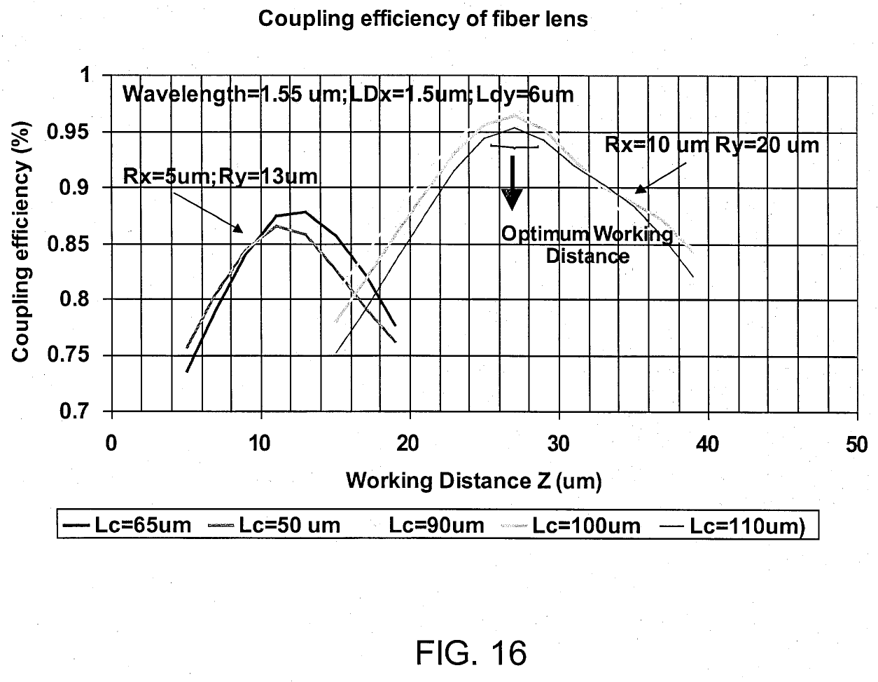

The results of the modeling on these examples are shown in FIG. 16. These results indicate that high coupling efficiencies and reasonable working distances are possible using this approach. In particular, the tolerances on the working distance is better with Set 2 where the optimum working distance is also larger.

The example is given for illustrative purposes only and will vary based on the applications. The foregoing example may be more clearly understood with reference to the following references: W. L. Emkey and C. Jack, Journal of Light Technology-Sep. 5, 1987, pp.1156-64; H. Kogelnik, Applied Optics, Dec. 4, 1965, p1562; R. Kishimoto, M. Koyama; Transactions on Microwave Theory and Applications, IEEE MTT-30, June 1982, p882; and Photonics by B. E. A. Saleh and M. C. Teich, John Wiley & Sons, Inc., 1991, each of which is hereby incorporated herein by reference. Additional aspects, features, and characteristics of the present invention may be found in the co-pending U.S. non-provisional application entitled, “Beam Altering Fiber Lens Device and Method of Manufacture,” which is commonly owned by Coming, Incorporated, filed on the same day herewith, and is hereby incorporated herein by reference.

While the invention has been described in detail, it is to be expressly understood that it will be apparent to persons skilled in the relevant art that the invention may be modified without departing from the spirit of the invention. Various changes of form, design or arrangement may be made to the invention without departing from the spirit and scope of the invention. For example, more than one spacer rod 46 may be employed in any of the embodiments described above. In addition, one of skill in the art will recognize that the various components/elements of lensed apparatus 40 of the present invention need not be manufactured from nor embody the same materials, provided the various materials forming the various elements of lensed apparatus 40 are compatible with respect to characteristics, such as, but not limited to, softening point, and coefficient of thermal expansion. Therefore, the above mentioned description is to be considered exemplary, rather than limiting, and the true scope of the invention is that defined in the following claims.

What is claimed is:

1. A lensed apparatus for altering the mode field of an optical signal, the apparatus comprising:
an optical fiber; and
a biconic lens disposed on an end of the optical fiber such that the optical fiber and the biconic lens define an optical axis, the biconic lens including an external surface defined by two different curves disposed substantially orthogonal to one another, a major curve C₁ and a minor curve C₂, wherein C₁ and C₂ intersect at or near the optical axis.

2. The lensed apparatus of claim 1 further comprising a spacer rod having a substantially uniform index of refraction disposed between the optical fiber and the biconic lens.

3. The lensed apparatus of claim 1 wherein the biconic lens defines a conic surface.

4. The lensed apparatus of claim 2 wherein the spacer rod comprises a tapered spacer rod.

5. The lensed apparatus of claim 2 wherein one or more of the optical fiber and the spacer rod include an alignment feature.

6. The lensed apparatus of claim 1 wherein both of the curves C₁ and C₂ each define a sphere.

7. The lensed apparatus of claim 1 wherein both of the curves C₁ and C₂ each define an asphere.

8. The lensed apparatus of claim 1 wherein one of the curves C₁ or C₂ defines an asphere while the other of the curves defines a sphere.

9. The lensed apparatus of claim 2 wherein the spacer rod comprises a non-cylindrical rod of light carrying material.

10. The lensed apparatus of claim 5 wherein the non-cylindrical rod comprises a substantially rectangular rod.

11. The lensed apparatus of claim 2 wherein the spacer rod comprises a plurality of spacer rods.

12. The lensed apparatus of claim 2 wherein the biconic lens is disposed on an end of the spacer rod remote from the optical fiber.

13. The lensed apparatus of claim 2 wherein one or more of the optical fiber and the spacer rod comprises a geometric shape other than cylindrical.

14. The lensed apparatus of claim 13 wherein the geometric shape comprises a rectangle.

15. The lensed apparatus of claim 13 wherein the geometric shape comprises a square.

16. The lensed apparatus of claim 13 wherein the geometric shape comprises an ellipsoid.

17. The lensed apparatus of claim 2 wherein each of the optical fiber and the spacer rod define an outside dimension and wherein the outside dimension differ in size from one another.

18. The lensed apparatus of claim 2 wherein each of the optical fiber and the spacer rod define an outside dimension and wherein the outside dimension are equal in size to one another.

19. A system comprising:
an optical component;
a substrate configured to support the optical component; and
the lensed apparatus of claim 1 positioned on the substrate and in relation to the optical component to change the mode field of an optical signal passed between the lensed apparatus and the optical component.

20. A method of manufacturing a lensed apparatus, the method comprising the steps of:
disposing a biconic lens on one end of an optical fiber such that the optical fiber and biconic lens define an optical axis, the biconic lens comprising an external surface defined by two different curves disposed substantially orthogonal to one another, a major curve C₁ and a minor curve C₂, wherein C₁ and C₂ intersect at or near the optical axis.

21. The method of claim 20 wherein the disposing step comprises the steps of attaching a spacer rod having a substnatially uniform index of refraction to the end of the optical fiber and shaping the end of the spacer rod remote from the optical fiber to form the biconic lens.

22. The method of claim 21 further comprising the step of removing a sufficient length of the spacer rod prior to the shaping step.

23. The method of claim 22 wherein the removing and shaping steps are performed before the attaching step.

24. The method of claim 22 wherein the removing and shaping steps are performed after the attaching step.

25. The method of claim 22 wherein the removing step comprises the step of cleaving the spacer rod.

26. The method of claim 25 wherein the shaping step comprises the step of laser micro-machining the cleaved end of the spacer rod.

27. The method of claim 25 wherein the shaping step comprises the steps of grinding and polishing the cleaved end of the spacer rod.

28. The method of claim 25 wherein the shaping step comprises the steps of grinding, polishing and heating the cleaved end of the spacer rod.

29. The method of claim 25 wherein the spacer rod comprises a rectangular rod and wherein the shaping step comprises the step of reflowing the cleaved end of the rectangular rod to the desired shape via heating.

30. The method of claim 29 wherein the shaping step further comprises the step of polishing the shaped end of the rectangular rod.

31. The method of claim 22 wherein the removing step comprises the step of taper cutting the spacer rod an operative distance away from the optical fiber.

32. The method of claim 31 wherein the shaping step comprises the step of heating the taper cut end of the rod to a temperature sufficient to round the external surface of the biconic lens.

33. The method of claim 32 wherein the shaping step further comprises the step of polishing the external surface of the biconic lens after the heating step.

34. The method of claim 22 wherein the removing step comprises the step of multi-taper cutting the spacer rod an operative distance away from the optical fiber.

35. The method of claim 34 wherein the shaping step further comprises the step of polishing the multi-taper cut end of the spacer rod to round the external surface of the biconic lens.

36. The method of claim 34 wherein the shaping step comprises the step of heating the multi-taper cut end of the spacer rod to round the external surface of the biconic lens.

37. The method of claim 36 wherein the shaping step further comprises the step of polishing the rounded external surface of the biconic lens.

38. An optical assembly comprising:
an optical component;
a substrate configured to support the component; and
a lensed apparatus positioned on the substrate and in relation to the optical component to change the mode field of an optical signal passed between the lensed apparatus and the optical component, wherein the lensed apparatus includes an optical fiber and a biconic lens disposed on an end of the optical fiber such that the optical fiber and the biconic lens define an optical axis, the biconic lens including an external surface defined by two different curves disposed substantially orthogonal to one another, a major curve C₁ and a minor curve C₂, wherein C₁ and C₂ intersect at or near the optical axis.

39. The optical assembly of claim 38 wherein the optical component is a laser diode and wherein the substrate is a silicon optical bench.

40. The optical assembly of claim 38 wherein the lensed apparatus further includes a spacer rod having a substantially uniform index of refraction disposed between the optical fiber and the biconic lens.

41. The optical assembly of claim 40 wherein the outside dimension of the optical fiber and the outside dimension of the spacer rod are substantially equal.

42. The optical assembly of claim 40 wherein the outside dimension of the optical fiber is less than the outside dimension of the spacer rod.

43. The optical assembly of claim 40 wherein the outside dimension of the optical fiber is greater than the outside dimension of the spacer rod.

44. The optical assembly of claim 40 wherein the spacer rod comprises a plurality of spacer rods, each having a substantially uniform index of refraction.

45. The optical assembly of claim 40 wherein one or more of the optical fiber and the spacer rod comprises a geometric shape other than cylindrical.

46. The optical assembly of claim 44 wherein one or more of the plurality of spacer rods is tapered.

47. The optical assembly of claim 44 wherein one or more of the optical fiber, and the plurality of spacer rods comprises a geometric shape other than cylindrical.

48. The optical assembly of claim 47 wherein one or more of the optical fiber, and the plurality of spacer rods include an alignment feature.

49. The optical assembly of claim 38 wherein the optical component is a semi-conductor optical amplifier and wherein the substrate is a silicon optical bench.

50. The optical assembly of claim 45 wherein the geometric shape is substantially rectangular.

51. The optical assembly of claim 45 wherein the geometric shape is substantially square.

52. The optical assembly of claim 45 wherein the geometric shape is substantially elliptical.

53. The optical assembly of claim 40 wherein the outside dimension of the spacer rod is less than the outside dimension of at least a portion of the biconic lens.
